(19) United States
(12) Patent Application Publication
(10) Pub. No.: US 2009/0229402 A1
(43) Pub. Date: Sep. 17, 2009

(54) BRAKE SYSTEM FOR HYBRID VEHICLE

(76) Inventors: Adil Khan, Lakeshore (CA); Daniel A. Villar, Canton, MI (US); Daniel Gabor, Canton, MI (US); Peter F. Worrel, Troy, MI (US)

Correspondence Address: Dickinson Wright PLLC, 38525 Woodward Avenue, Suite 2000, Bloomfield Hills, MI, 48304, US

(21) Appl. No.: 12/049,514

(22) Filed: Mar. 17, 2008

(51) Int. Cl. G05G 1/46

(52) U.S. Cl. 74/512

(57) ABSTRACT

A brake system for a hybrid vehicle includes a master cylinder, such as an active booster master cylinder, and a brake pedal mounted upon a pivoted brake pedal arm. A compliance device extends between the brake pedal arm and the master cylinder and includes a push rod and clevis assembly mating with the brake pedal arm. A composite drive pin including a resin sheath and a metallic core functions as part of the compliance device, by allowing limited motion between the brake pedal arm and brake pedal and the master cylinder push rod, so as to permit selective use of regenerative braking.

### CROSS REFERENCE TO RELATED APPLICATIONS

None.

### BACKGROUND OF THE INVENTION

1. Field of the Invention

The present invention relates to a brake system suited for use with a hybrid vehicle having both regenerative and friction braking on one or more axles.

2. Disclosure Information

Hybrid vehicles, whether powered by an internal combustion engine or otherwise, and using electric, hydraulic, or compressed gas or another energy storage medium, typically utilize regenerative and friction braking on one or more axles. Regenerative braking is a fixture of hybrid vehicles simply because energy which is usually lost during the braking process may be recovered and used for powering the vehicle. Because, however, regenerative braking is not available at times, due to, for example, the lack of storage capacity in a traction battery or pump storage reservoir, or during certain operating modes, it is necessary to provide hybrid vehicles with not only regenerative braking, but also friction braking.

When a vehicle is being braked regeneratively, it is desirable for the brake pedal travel and effort to be, to the extent possible, equivalent to the travel and effort necessary to achieve a given level of braking during operation solely with friction brakes. In order to achieve the desired transparency needed of operation both with and without regenerative capability, it is required that the vehicle's brake pedal be displaceable by the motorist, during regenerative braking, without resistance from the master cylinder used to apply the friction brakes. This requirement of non-interaction from the master cylinder may be satisfied by the accommodation of lost motion between the master cylinder push rod and the arm to which the brake pedal is attached. Known attachments between the brake cylinder push rod and brake pedal arm are very complex and difficult to assemble. Moreover, known devices use a drive pin centered by the outer surfaces of a clevis attached to the master cylinder, and this causes friction to develop between the drive pin's head and the clevis surfaces.

It would be desirable to provide a brake pedal and master cylinder arrangement allowing rapid and relatively effortless coupling of the brake booster/master cylinder push rod to the brake pedal arm, using a structure which minimizes annoying vibration and noise during operation of the vehicle.

It would further be desirable to employ a drive pin and pedal arm combination which center the drive pin through its interaction with the pedal arm, rather than through interaction of the drive pin with a clevis attached to the master cylinder or brake booster. In this manner, friction between the head of the drive pin and adjoining surfaces of the clevis is eliminated.

### SUMMARY OF THE INVENTION

According to an aspect of the present invention, a brake system for a hybrid vehicle includes a master cylinder connected with a number of wheel cylinders, and a brake pedal mounted upon a pivoted brake pedal arm which is adapted for mounting within the passenger compartment of the vehicle. The brake pedal arm has a bore extending therethrough. A compliance device extends between the brake pedal arm and the master cylinder. The compliance device includes a push rod having a first end attached to a master cylinder and a second, free end. A clevis is attached to the second end of the push rod. The clevis has a base engaging the push rod. A pair of opposing connecting members are integral with the clevis base. In a first embodiment, the opposing connection members each have a linear aperture extending generally parallel to a longitudinal axis of the push rod. A composite drive pin extends through the linear apertures and through the bore formed in the brake pedal arm in a direction generally perpendicular to the push rod. The composite drive pin includes a metallic core and a resin sheath applied to the core. The resin sheath has a generally cylindrical outer surface adapted to engage with both the bore formed in the brake pedal arm, and with the linear apertures. The resin sheath has a number of axial location abutments including at least one abutment which is radially displaceable so as to permit the drive pin to be readily assembled to the clevis and the brake pedal arm.

The composite drive pin preferably includes an anti-rotation cam extending radially outward from a portion of the generally cylindrical outer surface of the resin sheath. The anti-rotation cam is adapted to fit within a non-circular portion formed in the brake pedal arm bore.

In a first embodiment of the present invention, the opposing connecting members incorporated in the clevis are generally planar and configured such that the linear apertures in the connecting members have major axes which extend generally parallel to the longitudinal axis of the push rod. This is shown in FIGS. 5 and 6.

According to another aspect of the present invention, a master cylinder used with the present brake system is preferably configured as an active booster master cylinder, with the compliance device allowing the brake pedal to be depressed for a fraction of its normal travel, without applying the hydraulic brake system. This allows the use of regenerative braking in conjunction with friction braking in a manner which is transparent to the driver of the vehicle.

According to another aspect of the present invention, the axial location abutments formed on the resin sheath of the composite drive pin include a number of abutments positioned between the brake pedal arm and each of the opposing connecting members of the clevis. The axial location abutments are formed integrally with the resin sheath and are preferably created when the resin sheath is molded in place upon a metallic core. The abutments are preferably configured as radial displaceable sprags which are cantilevered to the resin sheath so as to normally project from the outer cylindrical surface of the resin sheath, with each sprag having a selectively retracted position enabling insertion of the composite drive pin within the clevis and bore formed in the brake pedal arm.

According to another aspect of the present invention, the axial abutments of the installed composite drive pin may be positioned within an internal annular groove formed within the bore of the brake pedal arm. As an alternative, the axial abutments may include an abutment positioned within an internal annulus defined by an outer surface of the composite drive pin and a bore formed within a doubler applied to the brake pedal arm such that the bore formed within the doubler is concentric with the bore formed in the brake pedal arm.

According to another aspect of the present invention, a brake system includes an active booster master cylinder connected with a number of wheel cylinders, with a brake pedal having a linear aperture extending through a brake pedal arm. A clevis has opposing connecting members which each have a generally cylindrical bore extending therethrough in a direction generally perpendicular to a push rod having a first end attached to the master cylinder and a second free end which is attached to the clevis. A composite drive pin extends through the bores formed in the connecting members and through the linear aperture formed in the brake pedal arm.

It is an advantage of a system according to the present invention that compliance may be provided between a brake pedal and an active booster master cylinder, with a minimum number of components in the compliance device, while avoiding undesirable noise, vibration and harshness from the connection between the master cylinder push rod and the brake pedal arm.

It is yet another advantage of a brake system according to the present invention that a connection may be made up between a brake pedal arm and a master cylinder push rod without the need for attaching threaded fasteners under the dash of a vehicle during the final assembly process.

It is yet another advantage of a brake system according to the present invention that necessary compliance between a brake pedal and a master cylinder is provided with minimal tooling cost.

It is an advantage of a system according to the present invention that compliance may be provided between a brake pedal and an active booster master cylinder with a minimum amount of friction within the compliance device.

Other advantages, as well as features of the present invention, will become apparent to the reader of this specification.

### BRIEF DESCRIPTION OF THE DRAWINGS

FIG. 1 is a side elevation of a brake system according to the present invention.

FIG. 2 is a side elevation similar to FIG. 1, but having a number of components removed for clarity of reading.

FIG. 3 is a perspective view showing insertion of a composite drive pin according to one aspect of the present invention.

FIG. 4 is a perspective view of a composite drive pin according to an aspect of the present invention.

FIG. 5 is a plan view of an embodiment according to one aspect of the present invention.

FIG. 6 is similar to FIG. 5, but shows another embodiment according to an aspect of the present invention.

FIG. 7 is similar to FIGS. 5 and 6, but shows yet another embodiment according to the present invention.

### DETAILED DESCRIPTION OF THE PREFERRED EMBODIMENTS

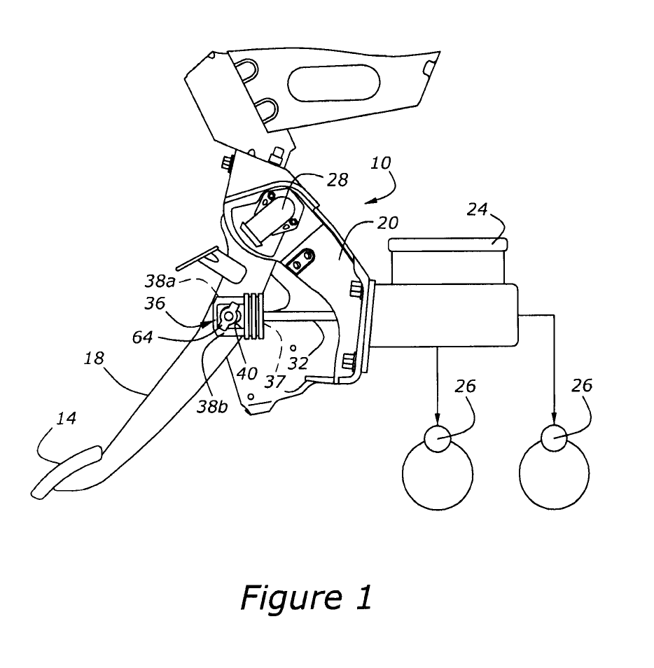

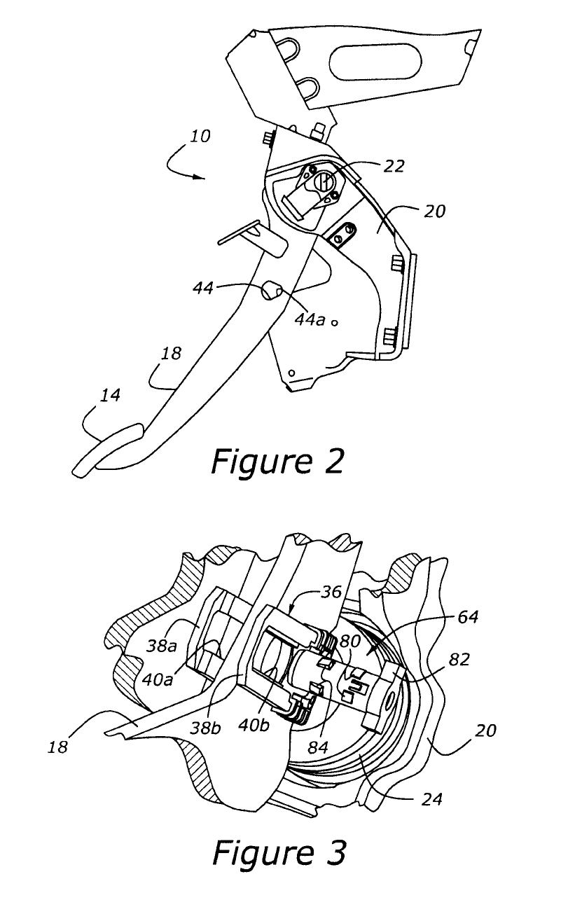

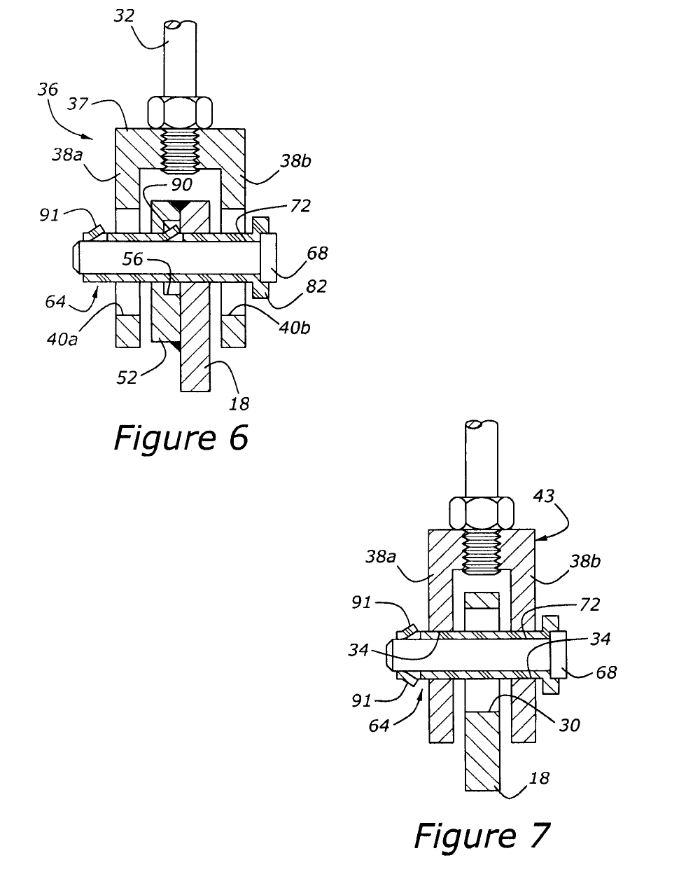

As shown in FIG. 1, active booster master cylinder 24 is connected with a number of wheel cylinders, 26. Master cylinder 24 is driven by push rod 32, having a first end attached to master cylinder 24 and a second end attached to clevis base 37, which is part of slotted clevis 36. Opposed connecting members 38a and b (shown with particularity in FIGS. 3, 5 and 6) have linear apertures, commonly termed “slots”, 40a and 40b, extending therethrough. Linear apertures 40a and 40b, are shown in FIGS. 5 and 6 as having major axes which extend generally parallel to the longitudinal axis, A, of push rod 32. A brake pedal travel sensor, 28, is coupled to brake pedal shaft 22 shown in FIG. 2.

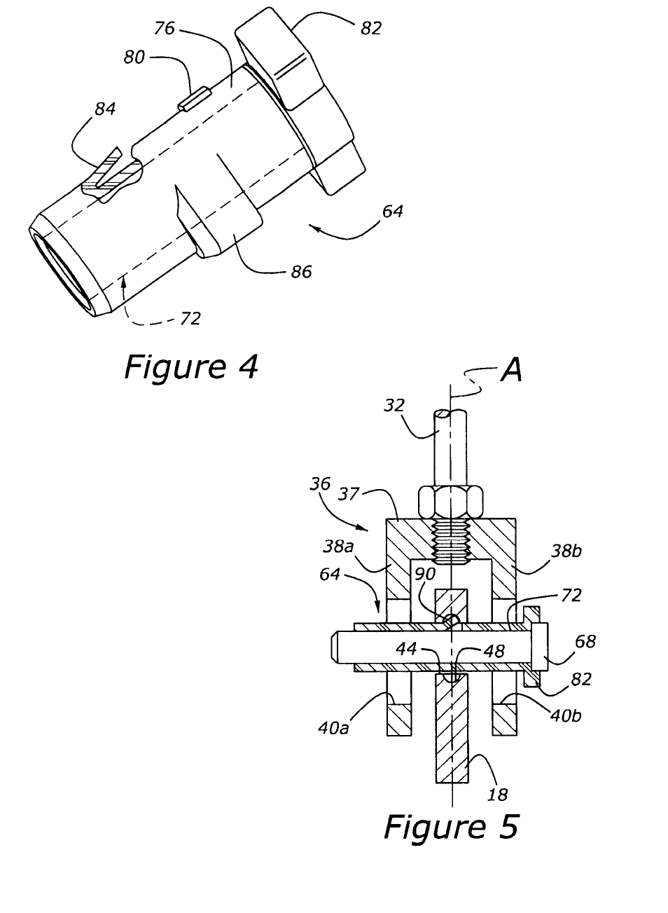

A brake pedal, 14, is attached to a brake pedal arm, 18, which is mounted to a bracket, 20, by means of a pivot shaft 22. FIG. 2 also shows with particularity a bore, 44, through brake pedal arm 18, with bore 44 having an anti-rotation cam slot illustrated as non-circular segment, 44a. Both bore 44 and non-circular segment 44a are engaged, as described below, by composite drive pin 64, which is shown with particularity in FIGS. 3 and 4.

FIGS. 3 and 4 show the external surfaces of drive pin 64. These external surfaces include a bar handle, 82, which is formed in external resin sheath, 72. Sheath 72 also includes an anti-rotation cam, 86, which is intended to slidingly fit within non-circular bore segment 44a of pedal arm 18. As shown in FIGS. 5-7, resin sheath 72 is preferably molded in place over metallic core 68. In a preferred embodiment, core 68 is configured from steel.

Composite drive pin 64 further includes at least one fixed abutment, 80, and at least one cantilevered, radially displaceable abutment or sprag, 84. As shown in FIG. 4, sprag 84 is cantilevered from, and formed integrally with, resin sheath 72 of composite drive pin 64.

Composite drive pin 64 is inserted, as shown in FIG. 3, by axially moving the composite drive pin through linear apertures 40a and b formed in opposing connecting members 38a and 38b, as well as through bore 44 formed in pedal arm 18. As composite drive pin 64 is inserted axially through these components, sprags 84 are at first compressed radially to allow passage through bore 44, and then the sprags move from their selectively retracted position to a normally extended position for retaining composite pin 64 centered within bore 44 of pedal arm 18.

In the embodiment shown in FIG. 3, composite drive pin 64 has fixed abutments 80, and sprags 84, all of which come to rest on either side of pedal arm 18 when composite drive pin 64 has been inserted into its fully installed position. In the embodiment of FIG. 5, however, one or more sprags 90, are employed at the midpoint of composite drive pin 64. Sprags 90 register with an internal annular groove, 48, formed in the aperture 44 of brake pedal arm 18. In each case, drive pin 64 is retained in a predetermined axial position in which only external sheath 72 contacts connecting members 38a and 38b. Essentially, drive pin 64 is locked axially upon pedal arm 18.

In the embodiment of FIG. 6, a doubler, 52, is applied to brake pedal arm 18, and a bore, 56, formed in doubler 52, combines with the outer cylindrical surface of composite drive pin 64 to define an annulus in which one or more cantilevered radially displaceable abutments, or sprags, 90 may be located when composite drive pin 64 is mounted in the fully installed location. As is further shown in FIG. 6, one or more cantilevered radially displaceable sprags 91 may be mounted at an end of composite drive pin 64 opposite bar handle 82.

In the embodiment of FIG. 7, opposing connecting members 38a and 38b have bores 34 formed therein. These bores 34 allow composite drive pin 64 to be securely mounted within clevis 43, so as to permit composite drive pin 64 to move reciprocally within slot 30 formed in brake pedal arm 18. As before, the presence of resin sheath 72 as the outer surface of composite drive pin 64 prevents unwanted noise, vibration, and harshness from being generated as the result of interaction of composite pin 64 with either clevis 43, or brake pedal arm 18. At least two radially displaceable abutments or sprags 91 are preferably located at the lead end of composite drive pin 64 in the configuration of FIG. 7.

Although the present invention has been described in connection with particular embodiments thereof, it is to be understood that various modifications, alterations, and adaptations may be made by those skilled in the art without departing from the spirit and scope of the invention set forth in the following claims.

What is claimed is:

1. A brake system for a hybrid vehicle, comprising:
a master cylinder connected with a plurality of wheel cylinders;
a brake pedal mounted upon a pivoted brake pedal arm adapted for mounting within a passenger compartment of a vehicle, with said brake pedal arm having a bore extending therethrough; and
a compliance device extending between said brake pedal arm and said master cylinder, with said compliance device comprising:
a pushrod having a first end attached to said master cylinder, and a second, free end;
a clevis attached to the second end of said pushrod, with said clevis having a base engaging said pushrod, and opposing connecting members integral with said base, with said opposing connecting members each having a linear aperture extending generally parallel to a longitudinal axis of said pushrod; and
a composite drive pin extending through said linear apertures and through said bore formed in said brake pedal arm, in a direction generally perpendicular to said pushrod, with said composite drive pin comprising:
a metallic core;
a resin sheath applied to said core, with said resin sheath having a generally cylindrical outer surface adapted to engage with the bore formed in said brake pedal arm, as well as with said linear apertures, and with said resin sheath having a plurality of axial location abutments comprising at least one abutment being radially displaceable, so as to permit the drive pin to be assembled to said clevis and said brake pedal arm, while being retained thereafter in a predetermined axial position.

2. A brake system according to claim 1, wherein said opposing connecting members are generally planar and configured such that said linear apertures have major axes which extend generally parallel to the longitudinal axis of said pushrod.

3. A brake system according to claim 1, wherein said master cylinder comprises an active booster master cylinder.

4. A brake system according to claim 1, wherein said axial location abutments comprise a plurality of abutments positioned between said brake pedal arm and each of said opposing connecting members of said clevis.

5. A brake system according to claim 1, wherein said axial location abutments are formed integrally with said resin sheath.

6. A brake system according to claim 1, wherein said axial location abutments comprise at least one abutment positioned within an internal annular groove formed within said bore of said brake pedal arm.

7. A brake system according to claim 1, wherein said metallic core of said composite drive pin comprises a generally cylindrical steel cylinder.

8. A brake system according to claim 1, wherein said metallic core of said composite drive pin comprises a generally cylindrical steel cylinder having a head formed on one end thereof.

9. A brake system according to claim 1, wherein said axial location abutments comprise at least one abutment positioned within an internal annulus defined by an outer surface of said composite drive pin and a bore formed within a doubler applied to said brake pedal arm such that the bore formed within the doubler is concentric with said bore formed in the brake pedal arm.

10. A brake system according to claim 1, wherein each of said radially displaceable abutments comprises a sprag which is cantilevered to, and formed integrally with, said resin sheath, with said sprag having a selectively retracted position, enabling insertion of said composite drive pin within said connecting member apertures and said brake arm bore, and a normally extended position for retaining said composite pin within said bore and said apertures.

11. A brake system according to claim 1, wherein said resin sheath is molded in place upon said metallic core.

12. A brake system according to claim 1, wherein said composite drive pin is locked axially upon said pedal arm.

13. A brake system according to claim 1, wherein said composite drive pin is locked axially upon said clevis.

14. A brake system for a hybrid vehicle, comprising:
an active master cylinder connected with a plurality of wheel cylinders;
a brake pedal mounted upon a brake pedal arm adapted for mounting upon a pivot shaft within a passenger compartment of a vehicle, with said brake pedal arm having a linear aperture extending therethrough; and
a compliance device extending between said brake pedal arm and said master cylinder, with said compliance device comprising:
a pushrod having a first end attached to said master cylinder, and a second, free end;
a clevis attached to the second end of said pushrod, with said clevis having a base engaging said pushrod, and opposing connecting members integral with said base, with said opposing connecting members each having a bore extending therethrough in a direction generally perpendicular to said pushrod; and
a composite drive pin extending through said bores formed in said connecting members and through said linear aperture formed in said brake pedal arm, with said composite drive pin comprising:
a metallic core;
a resin sheath applied to said core, with said resin sheath having a generally cylindrical outer surface engaging the linear aperture formed in said brake pedal arm, as well as said bores formed in the connecting members of said clevis, and with said resin sheath having a plurality of axial location abutments comprising at least one abutment being radially displaceable inwardly, so as to permit the drive pin to be assembled to said clevis and said brake arm.

15. A brake system according to claim 14, wherein each of said radially displaceable abutments comprises a sprag which is cantilevered from said resin sheath, with said sprag having a selectively retracted position enabling insertion of said composite drive pin within said connecting member bores and said linear aperture, and a normally extended position for retaining said composite pin within said bores and said aperture.

16. A brake system according to claim 14, wherein said bores formed in the connecting members of said clevis are generally cylindrical.
